(19) United States
(12) Patent Application Publication
(10) Pub. No.: US 2016/0005411 A1
(43) Pub. Date: Jan. 7, 2016

(54) VERSATILE MUSIC DISTRIBUTION

(71) Applicant: MERIDIAN AUDIO LIMITED, Huntingdon, Cambridgeshire (GB)

(72) Inventors: John Robert Stuart, Cambridge (GB); Richard J. Hollinshead, Warboys, Huntingdon (GB); Peter Graham Craven, Wimbledon (GB); Malcolm Law, Steyning (GB)

(21) Appl. No.: 14/765,916

(22) PCT Filed: Feb. 13, 2014
(86) PCT No.: PCT/GB2014/050423

§ 371 Date: Aug. 5, 2015

(30) Foreign Application Priority Data
Feb. 13, 2013 (GB) 1302547.3
Apr. 30, 2013 (GB) 1307795.3

(51) Int. Cl. G10L 19/018; G11B 20/00; H04L 9/08; G10L 19/16

(52) U.S. Cl. CPC G10L 19/018; G10L 19/167; G11B 20/00195; G11B 20/00289; G11B 20/00891; H04L 9/0891

(57) ABSTRACT

Methods and devices are described whereby a representation of an original PCM signal may be reversibly degraded in a controlled manner and information losslessly embedded to produce a streamable PCM signal, which provides a controlled audio quality when played on standard players and conditional access to a lossless presentation of the original PCM signal. Using such techniques allows control over the level of degradation of the signal and also flexibility in the type information of information embedded. Some methods require a song key, which is employed in one or both of the degrading and embedding steps and for creating a token. These methods may further require a user key, which is used to encrypt the song key before creating the token.

### CROSS-REFERENCED TO RELATED APPLICATION

This application is a U.S. National Stage filing under 35 U.S.C. §371 and 35 U.S.C. §119, based on and claiming benefit of and priority to PCT/GB2014/050423 for “VERSATILE MUSIC DISTRIBUTION” filed Feb. 13, 2014, and further claiming benefit of and priorities to GB patent application no. 1302547.3 filed Feb. 13, 2013 and GB patent application no. 1307795.3 filed Apr. 30, 2013.

### FIELD OF INVENTION

The invention relates to the distribution of music and other material in digital form, with particular reference to downloads.

### BACKGROUND TO THE INVENTION

Music distribution is now increasingly by streaming or download, but often at less-than-CD quality using a lossy compression system such as MP3. The music may be stored on the purchaser's computer or on portable playback devices as files in a lossy format, or as binary PCM (Pulse Code Modulation), usually encapsulated in a file format such as as WAV or AIFF, or in a losslessly compressed format such as FLAC.

A pure PCM file contains no information, or “metadata”, other than the digital audio signal itself. Encapsulation as WAV or AIFF provides the possibility of identification in a header at the start of the file, e.g. as an Ogg, ID3 or UITS header, but this is easily stripped off by a technically-aware person's software tool without any modification to the audio content, which can then be passed on to another person, possibly in breach of copyright, in which case the rights owner has no means to trace the source of the unauthorised copy.

Various schemes for “Digital Rights Management” have been proposed to make it technically less easy for a purchaser of a song to pass a copy to another person, however these schemes have tended to inconvenience or restrict the legitimate user, and have not gained widespread market acceptance. Other schemes have been proposed to make it possible for a rights holder to identify the original purchaser of a copy, however these either degrade the audio content through watermarking or rely on file headers which can be removed by a technically-aware person.

More fundamentally, a culture of obtaining music without payment has developed in some quarters, and it can be difficult to persuade people to pay for something that they have previously had for free. However, the culture of free music is generally in the context of MP3 quality. An opportunity exists to build a market for better-than-MP3 sound quality, especially if the purchaser of the better version can be given assurance that it really is better, even though he or she may or may not be able to reliably appreciate the difference on casual listening or on inferior reproduction equipment.

These ideas have been explored in the prior art, wherein “superdistribution” refers to the provision of a song file that can be freely disseminated on a peer-to-peer basis, but will not provide full quality reproduction until a suitable key, which may be unique to each user, has been acquired. “Perceptual encryption” is the process of deliberately degrading a song in a manner that is reversible or substantially reversible by a person in possession of a suitable decryption key.

Thus a free but lower quality version of a song may be regarded as a highly effective advertisement, familiarising the listener with the musical intent and giving him a clearer basis to spend money on a higher quality version. However prior art methods (described for example in “Device and method for producing an encoded audio and/or video data stream” by E. Allemanche et al., U.S. Pat. No. 7,308,099, December 2007) have tended to rely on specific container file formats rather than allowing dissemination as an ordinary PCM file, and some prior proposals have also not had the ability to recover a truly lossless version of the original signal even when the appropriate key has been acquired.

The methods of the current invention can support several commercial models for distributing audio in which the delivered file can convey a compatible but reduced quality but whose full quality can be decoded and confirmed by methods which combine Song and Device and User keys. The distribution methods may be: “Informative” where the decoder confirms that a legitimate stream is decoded by a legitimate decoder; “Restrictive” where the transaction server can limit the full quality playback to combinations of Users and Devices; “Trace” wherein songs contain embedded information which may displayed in whole or in part during playback or forensically, the removal of which prevents subsequent lossless recovery; “Positive” where the previous methods can provide an enhanced yet restricted distribution wherein the server permits copies to be gifted from one User to another.

### SUMMARY OF THE INVENTION

The invention provides a method of creating a streamable PCM signal allowing conditional access to a lossless presentation of an original PCM signal, where the streamable PCM signal has the same sample rate and bit-depth as the original PCM signal. Thus, the streamable PCM signal can be played on the existing ‘infrastructure’ of players including personal players, many of which are restricted to a sample rate of 44.1 khz or 48 kHz, and to a bit-depth of 16 bits or 24 bits. The invention allows the quality of the playback on such existing devices to be adjusted over a range from, ideally, an imperceptible impairment relative to the lossless presentation to a distinctly audible impairment, whilst allowing conditional access to a lossless presentation of an original PCM signal with the suitable equipment.

In a first aspect, the method comprises the steps of:
reversibly degrading a representation of the original PCM signal in dependence on degradation information for degrading the original PCM signal;
embedding the degradation information into the representation using a method of lossless watermarking;
creating a token in dependence on additional information; and,
inserting the token into the degraded representation to provide the streamable PCM signal.

Necessarily a lossless watermarking method reduces the quality of playback on existing devices but the intention is to choose a watermarking method that imposes minimal quality reduction so that the final quality can be controlled over a wide range from an imperceptible impairment to a significant impairment, by adjusting the severity of the degradation introduced by the step of reversibly degrading.

The additional information may take several forms and may include: a song key as described below, verification information, a digital signature, transaction tracing information, or copyright or ownership information such as in an “ISRC” code, or a combination of these.

The step of inserting the token will normally be performed periodically so that the information contained therein will be available even if the stream is not played from the beginning; insertion at regular intervals generally being helpful to a decoder.

The degrading and embedding steps may be performed in either order or conceptually within a single step.

Preferably, the degradation information comprises degradation instructions, which allow control over the form and degree of degradation.

In some preferred embodiments, the method further comprises the step of receiving a song key, wherein at least one of the reversibly degrading step and the embedding step is performed in dependence on the song key, and wherein the token is created in dependence on the song key.

In such embodiments, the method may further comprise the steps of:
receiving a user key; and,
encrypting the song key with the user key to furnish a user encrypted song key, wherein the token is created in dependence on the user encrypted song key.

According to the method of the first aspect, a mutable digital representation of the song or of part of the song, for example a digital copy, is processed as specified by the steps. If it is a copy, it need not be a copy of the whole song, since it would be normal to process a song in segments stored temporarily in the memory of a computer. The representation is deliberately degraded in a reversible manner, for example by applying a time-varying gain as described in published International patent application WO2013/061062, incorporated herein by reference, so as to provide a lower sound quality when the song is played by an unaware player as if it were a standard PCM signal.

The degradation is not arbitrary but is controlled by degradation information which has two purposes. The first purpose is to allow the degradation to be reversed on playback; the second is to allow the degradation to be selected on artistic, aesthetic or commercial grounds by the artist or his representative and to be consistent for all account-holders who may purchase the song.

To facilitate the first purpose, the degradation information is embedded into the representation using a method of lossless watermarking, also known as lossless buried data, for example as described in published International patent application WO2013/061062. To facilitate the second purpose, the method may be enhanced by extending the step of receiving to include receiving degradation information so that the artist can specify the degree of degradation he or she desires.

A playback device may retrieve the degradation information by decoding the lossless watermark and thus reverse the degradation. However, in order that the reversal may be conditional on appropriate authorisation, the reversible degradation may be performed in dependence on a song key so that only a player that has been provided with the song key will be able to reverse the degradation. Alternatively, the embedding step may be performed in dependence on the song key so that only players with the song key will be able to retrieve the degradation instructions that are contained within the watermark. For still greater security, both the reversible degradation and the embedding may be performed in dependence on the song key.

Here the song key is a secret key unique to the song, while the user key is unique to an account-holder who is registered with a central repository which manages registration and other transactions, typically via the Internet. Conceptually, the method is performed independently for each transaction, though in practice some steps may be common to all transactions and thereby be performed just once per song.

It is assumed that the account holder will possess one or more players, each of which is able to decrypt an item that has been encrypted with a user key specific to the account holder, and also possibly with shared user keys or a universal user key that is common to everyone. The method encrypts the song key with an appropriate user key so that only players that know that user key may retrieve the song key, which is generally common between performances of the method on a given song. This feature allows the steps of reversibly degrading and embedding to be performed once and the result stored in a server, only the remaining steps being repeated for each transaction relating to a given song.

The resulting user-encrypted song key (UESK) is then optionally combined with other items to form a token that is periodically inserted into the degraded representation to furnish the streamable PCM signal. Because the insertion is periodic, a player that does not receive the beginning of a streamed song is nevertheless able to retrieve the UESK and thus, if it knows the correct user key, decrypt the song key and play the remainder of the song with the degradation reversed.

If no other item is required, the token may consist of the UESK alone. Conversely, in order to address the technical requirements needed to support a range of business models known as Positive Rights Management, the UESK may consist of the Song Key encrypted with a combination of the User Key and other relevant information such as User Identifier. The User Identifier or other information may be also be placed in the stream in unencrypted form so that it may be retrieved without keys; moreover said information cannot be removed from the stream without preventing a standard player from decrypting the Song Key. Another possibility is a User Key which describes a set of two or more Users, for example where a family may reasonably share playback devices, while a yet further possibility is a generic key which allows unrestricted decoding of the song at high quality.

In general, degradation will be governed by instructions or parameters, which specify such things as the amount or quality of the modification introduced and are therefore comprised within the degradation information. There will also advantageously be a pseudorandom element to the degradation, for which a source of pseudorandom numbers, synchronised between an encoder and a decoder, is required. If a cryptographically secure random number generator is used, keyed by the song key, the degradation will thereby depend on the song key independently of whether parameters are encrypted.

According to the precise nature of the lossless watermarking process used, it may be convenient to encrypt degradation information either before or after the embedding has taken place.

In the case of a song streamed to a player but not from the beginning, it may be difficult for a decoder to know how to start. It is thus helpful to be able to look for regular patterns in the stream, and to this end the method preferably extracts signal information from a set of predetermined bit positions within the representation so that the token containing the UESK and possibly also an identifiable synchronisation pattern can be periodically inserted into the said predetermined bit positions. The signal information that was extracted from those bit positions is then embedded into the remainder of the representation; that is excluding the bit positions in the predetermined set.

In order that the listener may receive confirmation that the degradation has indeed been reversed losslessly, the method is preferably enhanced to comprise the further step of embedding verification information into the degraded representation and thereby also into the streamable PCM signal. For the purpose of verification the signals will generally be considered as consisting of segments and verification information computed for each segment in dependence on the segment of the original PCM signal. To discourage forgery, the verification information preferably comprises a digital signature.

To assist some models of rights management, it is sometimes desirable for the song to contain tracing information, which may relate to the account holder or to a transaction. To this end, the method may be enhanced to comprise the further step of receiving the tracing information relating to the user or transaction, this tracing information then being combined with the UESK and possibly other items to form the token. Since an attacker could then attempt to remove the tracing information by altering the token, preferably the verification information should also be computed in dependence on the token, so that the tracing information cannot easily be tampered with without causing the verification to fail.

In some embodiments, the steps of the method are all performed within a server and the streamable PCM signal then streamed directly to a player via the Internet, possibly in a losslessly compressed format, either for simultaneous playback or for later playback via local storage. In other embodiments, the account holder has a computer that acts as a client and is able to receive the degraded representation and the token separately, and then periodically insert the token into predetermined bit positions within the representation, a process we shall call “sprinkling”. Thus the method is enhanced to comprise the further step of transmitting the degraded representation and the token to a client prior to the step of inserting. This enhancement potentially transfers some computational load or temporary storage from the server to the client, since the degraded representation prior to transmission can be identical for all instances of the same song, and creation of the token can be a lightweight operation.

To ensure the correct conditional access, a mechanism is needed to ensure that each playback device contains an appropriate set of user keys, where such are required. To this end, the method may enhanced to comprise the further steps of:
establishing a secret device key relating to a playback device;
encrypting the user key with the device key; and,
communicating the device-encrypted user key to the device.

The second of these steps, that of encrypting the user key, furnishes a device-encrypted user key (DEUK). These further steps would normally be performed by a server, which will have knowledge of the user key that is relevant to each transaction. The user key will be used by authorised devices, but will be stored securely within those devices and known only to the devices and secure servers. Thus, communication of the user key requires encryption thereof and normally this will be done with a unique device key that is specific to a single playback device.

In some embodiments, a device may have both a unique identifier and a device key possibly allocated at manufacture, the identifier being public and linked to the device key in a secure database held by the server. In this case the step of establishing a secret device key will preferably comprise the steps of:
receiving a device identifier; and,
retrieving the secret device key from the database

This enhancement to the method supports embodiments in which only unidirectional communication is possible from server to device, as is the case for example when the communication is via portable storage or player and the decoder device is not connected to the Internet, such as a dock. In this case the device identifier may be communicated manually using an Internet application.

Once the server has produced the device-encrypted user key, this may be communicated to a playback device by any available method. However for user-convenience, the method is preferably enhanced so that the step of communicating the device-encrypted user key comprises the steps of:
selecting a segment of PCM audio material;
hiding the device-encrypted user key in the PCM audio material; and,
communicating the segment of PCM audio material to the playback device.

Thus, the step of communicating the device-encrypted user key appears to the user as if a special song has been streamed.

In a second aspect, the method of the present invention provides a streamable PCM signal allowing conditional access to a lossless presentation of an original PCM signal and to additional information, the streamable PCM signal having the same sample rate and bit-depth as the original PCM signal and providing a controlled audio quality when played on standard players, wherein the method comprises the steps of:
reversibly degrading a representation of the original PCM signal in dependence on degradation information for degrading the original PCM signal;
embedding the degradation information and additional information into the representation using a method of lossless watermarking;
creating a token in dependence on the additional information; and,
inserting the token into the degraded representation to provide the streamable PCM signal.

In this way, degradation information and additional information is losslessly buried in the representation and conditional access is provided to the lossless presentation of an original PCM signal and to the additional information.

The additional information may take many forms, including one or more of verification information, digital signature, received tracing information relating to a user or transaction, file source or copyright declaration.

In a third aspect, a streamable PCM signal is produced by any of the aformementioned methods

In a fourth aspect, a non-transitory computer readable medium comprises a streamable PCM signal produced by any of the aformementioned methods.

In a fifth aspect, a computer program product comprises executable instructions which, when executed by one or more processors of one or more electronic devices, cause said one or more electronic devices to perform any of the aformementioned methods

In a sixth aspect, an electronic device comprising:
one or more processors; and,
memory comprising instructions which, when executed by one or more of the processors, cause the electronic device to perform any of the aformementioned methods.

In a seventh aspect, a system comprises two or more electronic device, wherein each device comprises:
one or more processors; and,
memory comprising instructions which, when executed by one or more of the processors, cause the electronic devices to perform any of the aformementioned methods.

A will be appreciated, the invention provides methods and devices whereby a representation of an original PCM signal may be reversibly degraded and information embedded losslessly to produce a streamable PCM signal, which provides a controlled audio quality when played on standard players and conditional access to a lossless presentation of the original PCM signal. Using such techniques allows control over the level of degradation of the signal and also flexibility in the type information of information embedded.

### BRIEF DESCRIPTION OF THE DRAWINGS

Examples of the present invention will be described in detail with reference to the accompanying drawings, in which:

FIG. 1 shows a key management structure wherein a song is encrypted with a song key and streamed via a unidirectional path to a playback device;

FIG. 2 shows a song degraded according to the invention, stored in a server and then downloaded to a user's computer which sprinkles a song key and subsequently streams to the user's player connected to a playback device which uses the sprinkled song key to reverse the degradation;

FIG. 3 is akin to FIG. 2 except that sprinkling is performed in the server and the song with sprinkled information is streamed directly via the Internet to the user's player;

FIG. 4 shows an encoding process according to the invention;

FIG. 5 shows a decoding process corresponding to FIG. 4.

FIG. 6 shows the creation of a hole in an original PCM stream and the insertion of a token into the hole;

FIG. 7 shows the extraction of a token from a hole in a streamed audio song and the restoration of the original contents of the hole;

FIG. 8 shows detail of a data packet that may be inserted according to the invention;

FIG. 9 shows how verification and tracing information may be combined and signed, and the signature and placed into a hole;

FIG. 10 shows how a digital signature may be retrieved from a hole and used to verify both correct recovery of an audio signal and tracing information;

FIG. 11 shows an apparatus comprising (a) an encoder and (b) a decoder that may be used to perform the lossless burying of additional data within a PCM audio stream; and,

FIG. 12 shows an apparatus comprising (a) an encoder and (b) a decoder akin to the apparatus of FIG. 11 with the ability to receive a signal r such as a dither signal to adjust the sound of the composite signal.

### DETAILED DESCRIPTION

Central to the invention is the idea that a signal may be modified reversibly, so that the original signal may be recovered given knowledge of the modification process.

In the case of an audio signal, one such reversible modification method is to adjust the gain in a time-varying manner, the original signal then being recovered by applying the inverse gain. In other words, the audio signal may be multiplied by a constant plus another signal which may be chosen to have noiselike qualities, for example pink noise which will result in a modification akin to the addition of “modulation noise”, an artefact well known to the users of analogue magnetic recording tape.

Other modification methods include use of time-varying filters, the introduction of reversible nonlinearities and the introduction of pre- and/or post-echoes. However, a number of modification algorithms that might otherwise seem attractive are excluded by the desire to enable lossless bit-for-bit reconstruction of an original digital signal.

A simple unvarying signal modification, such as a filter or a nonlinear process, will not provide security against an unlicensed person who has only to determine the process or a small number of configuration parameters for the process in order to reverse the degradation and reconstruct an entire song. Hence a time-varying modification that depends on a stream of parameters, co-temporal with the signal, is preferred. The unlicensed person must then repeat the determination separately for each segment of the stream on order to reverse the modification; moreover the determination is more difficult since it has to be based on analysis of a shorter segment of the signal.

Thus a time-varying reversible modification allows the song to be distributed freely in a degraded form, while licensed listeners may be provided with a file containing instructions from which their playback devices are able to regenerate the stream of modification parameters and so are able to reverse the modification and thereby reconstruct the undegraded version of the song. The instructions may include seeds from which streams of pseudorandom numbers may be generated in a cryptographically secure manner, thus allowing a rich complexity of modifications to be described in a compact manner.

As a “key” to the song, the file of modification parameters can be much smaller than the song itself, but may still be inconveniently large. Moreover, a requirement to keep together two files, the song file and the parameter file, is in practice irksome to the user. This problem can be partially solved by burying the stream of modification parameters within the song file. In the context that lossless reconstruction is required, the burying must be done losslessly, using a method of lossless buried data, also known as lossless watermarking or invertible watermarking. In this document, references to “watermarking” and “watermarked audio” refer to invertible watermarking.

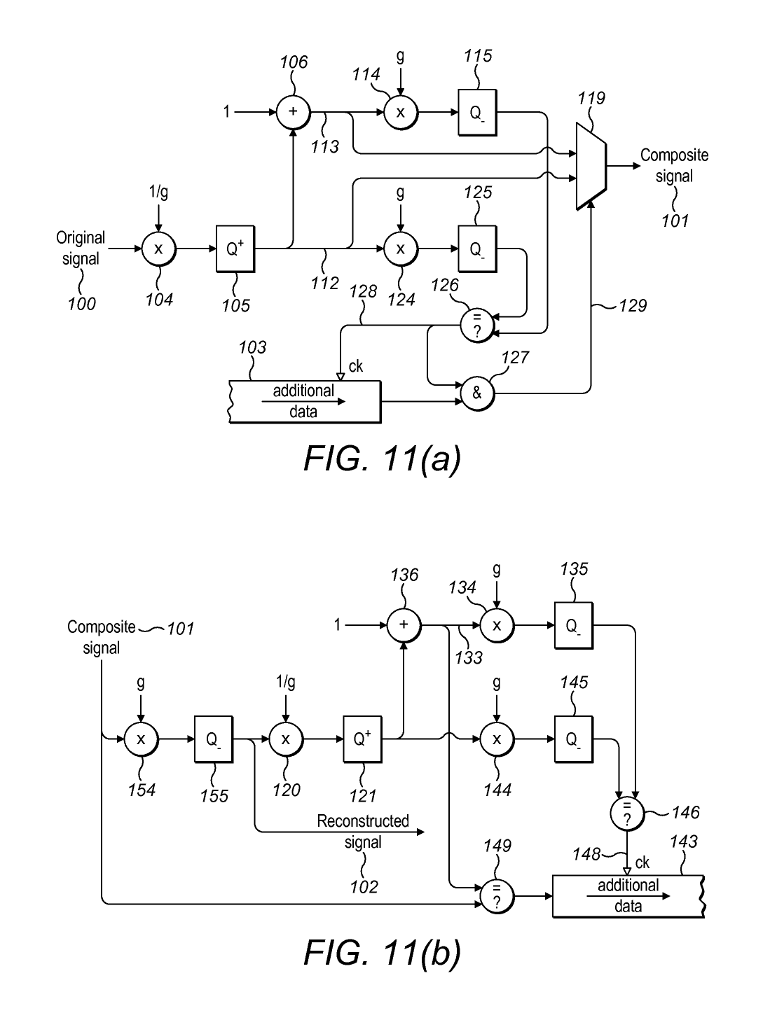

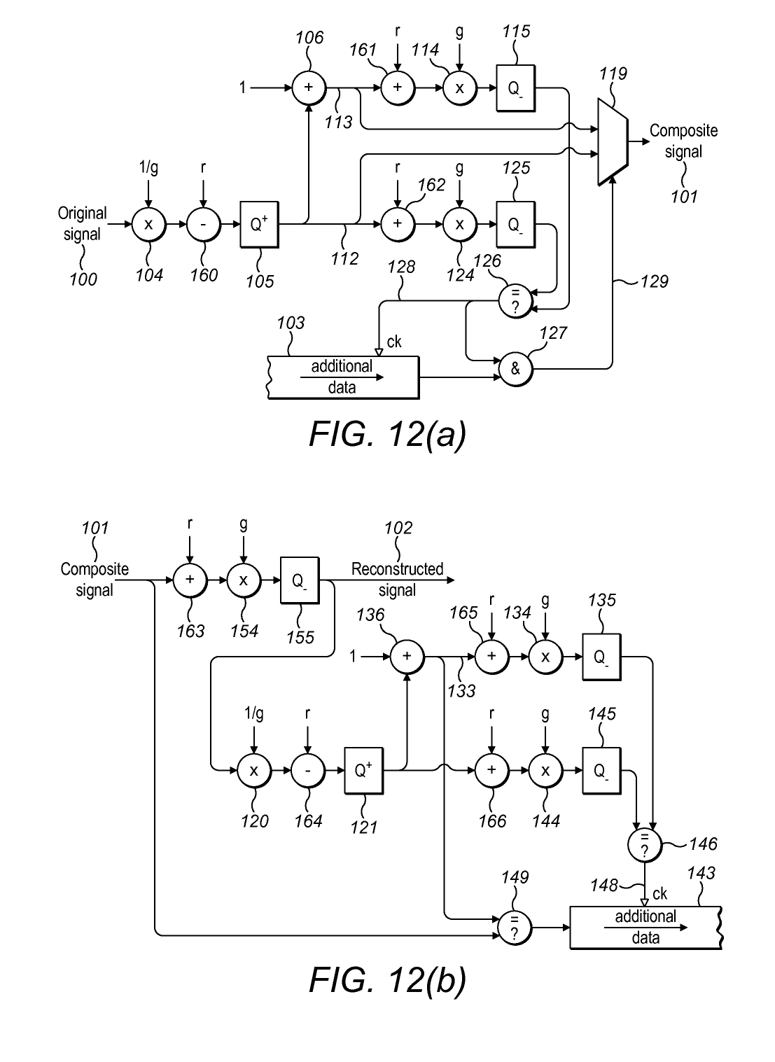

One method of losslessly burying data was described in published UK patent application GB2495918 and in published International patent application WO2013/061062, the content of which is incorporated by reference. Another embodiment of the same method will be discussed later with reference to FIG. 11 and FIG. 12 under the heading “Further example of lossless data burying apparatus”.

Another method is apparently disclosed in “Watermarking-Based Digital Audio Data Authentication” by Martin Steinbach and Janna Dittman, EURASIP Journal on Applied Signal Processing 2003:10, pp. 1001-1015 with particular reference to Section 3: “Invertible Audio Watermarking”. However, it appears unlikely that the algorithm described therein would provide the imperceptible impairment that is required, except in special situations. In several of the examples given in table 4 and table 5, Steinbach and Dittman claim that a bit compression algorithm was able to bury sufficient data by considering only the least significant bit, identified as bit #0. However, it is well known that dither should be used to produce a high quality recording, in which case the least significant bit has little or no redundancy to support the lossless burying of data. Conversely, in other examples where it is found necessary to operate on bit #8, it is inevitable that bit compression will produce an audible result that is at best hissy and at worst gritty and unpleasant. The bit-compression algorithm is not disclosed.

Time-varying modification parameters can be generated by suitable processing of a stream of pseudorandom numbers. A pair of pseudorandom number generators, one in an encoder and one in the corresponding decoder, identical and seeded identically, can be used to provide the encoder and decoder with identical streams of modification parameters and thus obviate the need to communicate a stream of parameters, whether buried or carried separately. In a possible embodiment, a seed and other configuration variables are stored at the beginning of the degraded file as a short preamble to the audio information, encrypted with a “song key” so that only licensed decoders may recover the seed and configuration variables and hence generate the entire stream of modification parameters.

However, such a preamble does not allow the configuration parameters to be adjusted partway through a song. Moreover, a decoder may not be able to access the beginning of an encoded stream if the decoder is a contained in a “dock” receiving a PCM stream from a personal player such as an iPod, and the user has started playback partway through the original song. To support this mode of operation, the information required to start lossless reconstruction must be repeated frequently through the stream, for example once per second. To provide a fast response for the user, a decoder can route the undecoded audio signal to its output to provide a degraded output until full reconstruction can be established.

### Rights Management

We now describe how the invention may be used in rights management systems, some of which have features in common with those described in “Analysis And Enhancement of Apple's Fairplay Digital Rights Management” by R. Venkataramu, MSc thesis, San Jose State University, May 2007, accessible as http://www.cs.sjsu.edu/faculty/stamp/students/RamyaVenkataramu_CS298Repor t.pdf. In the following, the term “user” refers to the “account holder” or to some other person who is authorised to play a song at high quality.

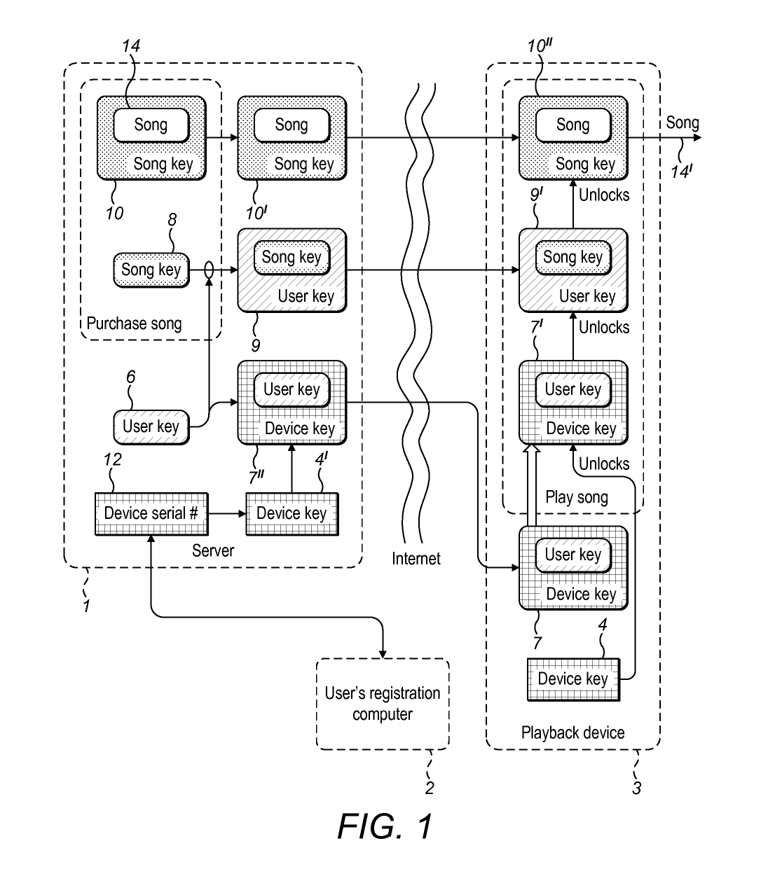

FIG. 1 shows a simple key management system in which a song 14 is assumed to be encrypted with a song key 8 and the encrypted song 10 stored in an Internet server 1. On the creation of a user account, the server establishes a user key 6 which is also stored but not communicated to the user except in encrypted form 7″.

The user may register one or more playback devices 3 by typing a device identifier unique to each device into a computer 2 which connects to the server 1 via the Internet. Each playback device contains a “device key” 4 which is an encryption key stored in secure memory in the device and otherwise secret except for an entry in a secure look-up table 12 in the server. On receiving the device identifier, the server retrieves a copy 4′ of device key from the look-up table and uses it to encrypt the user key, to furnish a Device Encrypted User Key (DEUK) which can be stored 7″ for transmission at some convenient time to the device 3 where it can be stored 7.

On purchase of the song 14, the server encrypts the song key 8 with the user key 6 to furnish the User Encrypted Song Key (UESK) 9 which can then be transferred to the playback device 3 and stored 9′. To play the song, the encrypted song 10′ is streamed to the playback device 3 via the Internet. The device 3 then retrieves the song 14′ by means of a triple decryption: using its device key 4 it unlocks the DEUK 7′ to furnish the user key which now unlocks the UESK 9′ to furnish the song key which now unlocks the encrypted song 10″.

It is to be noted that the decrypted device key and the decrypted song key are stored transiently in secure RAM during this playback process. The decrypted song 14′ is likewise preferably not made available to the outside world until converted to analogue form in a digital-to-analogue converter (DAC).

The separation of a user key from a device key in this manner allows a user to register several devices to his account: a new device can be added and will be able to play all songs that the user has already purchased as soon as it has been registered and has received a DEUK 7. It is also possible for a single device to be registered to more than one user account: in that case the device must store a DEUK for each such user.

Degradation with Buried Data

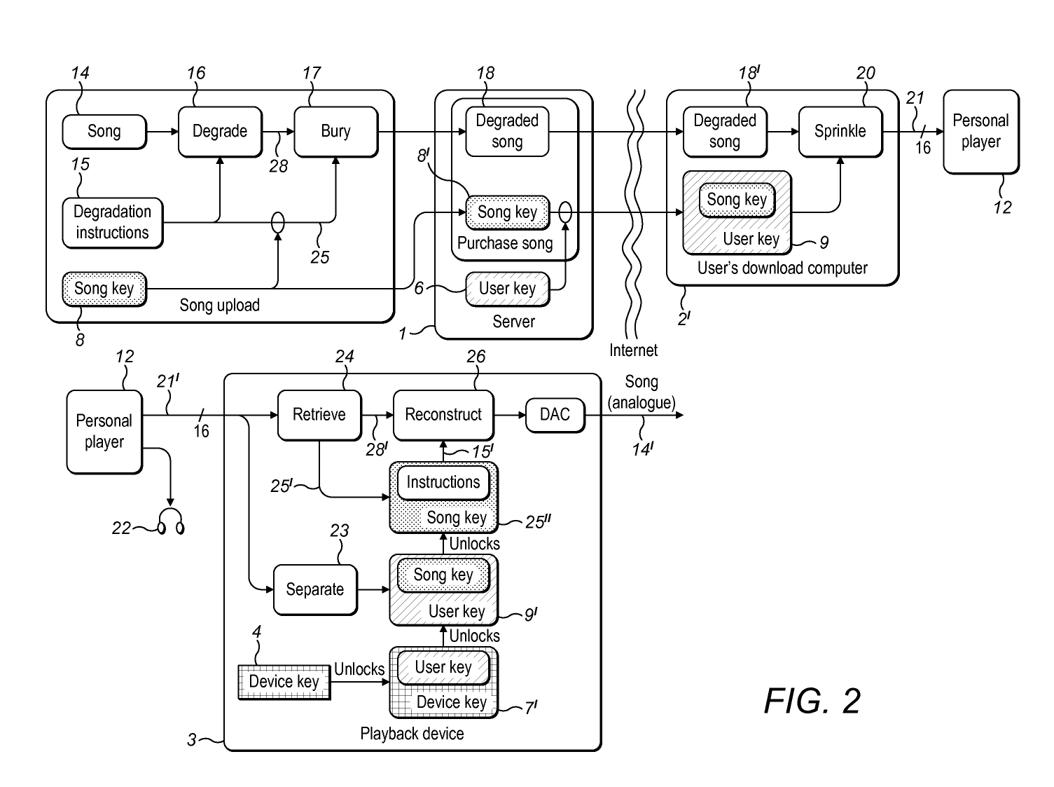

FIG. 2 shows a more advanced scheme incorporating some aspects of the invention, whereby the song 14 is degraded 16 as part of an uploading process before being stored on the server 1. The degradation is reversible and is performed in dependence on degradation instructions 15. In order to reverse the degradation a player will need to have access to the instructions 15. Accordingly these instructions are buried 17 in the degraded song 28 using a method of lossless watermarking, but prior to being buried the instructions 15 are encrypted with the song key 8 to furnish encrypted instructions 25 that are buried.

Subsequently, within the playback device 3 a replica 25′, 25″ of the encrypted instructions 25 will be retrieved 24 from the watermarked stream 21′. The player 3 obtains the UESK 9′ by a method to be described and so is able to decrypt the encrypted instructions 25′ to furnish replica instructions 15′ and so to reconstruct 26 the song 14′. That is, reconstruction 26 reverses the degradation process 16. As noted, it is preferred that the device 3 incorporate a digital-to-analogue converter (DAC) so that the reconstructed song 14′ is available externally only in analogue form.

In FIG. 2 the user is assumed to have a computer 2′ for downloading but will transfer the song to a player 12 for listening. The degraded version of the song can be auditioned through headphones 22 attached directly to a standard player, or via a playback device 3 according to the invention which may be either built in to the player or attached as a separate unit, for example as a ‘dock’ 3 attached to an ‘iPod’ or ‘Phone’ 12.

Such a playback device 3 needs to have access to the UESK. It is most convenient if the UESK is repeatedly buried within the stream 21 or 21′, for example once per second so that the playback device 3 may retrieve it even if the user requests the player 12 to begin the streaming from partway through the song. The watermarking process 17 could bury the UESK repeatedly, but this process has a computational cost and it is therefore preferred to perform it only once for the song rather than separately within the server 3 for each purchase transaction. Accordingly, it is arranged that the watermarking process 17 creates ‘holes’ in the stream: these are uncommitted bit positions whose values do not affect the output 28′ of the retrieval process 24. Typically the holes are placed in the least significant bit positions of the degraded stream (for example, the 16th bit) so that information such as the UESK may be ‘sprinkled’ 20 into them with minimal audible effect if the stream is auditioned 22 without a special playback device 3. The sprinkled information could alternatively or additionally include verification information, a digital signature, transaction tracing information, or copyright or ownership information such as in an “ISRC” code.

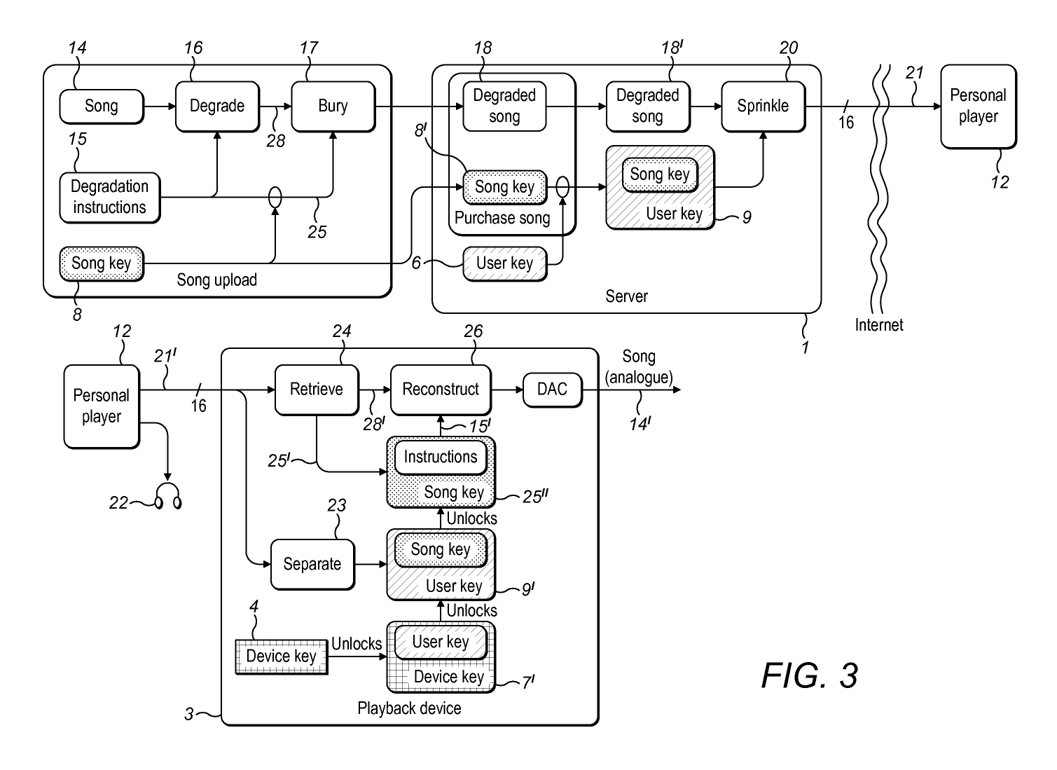

Following the watermarking process, the degraded song 18 and the song key 8′ are stored in the server 1 awaiting a purchase transaction. FIG. 2 and FIG. 3 illustrate, respectively, a download model and a streaming model for the transfer for the song and the song key to the user.

Under the download model, FIG. 2, the user has a computer 2′ which receives the degraded song 18′ either as part of the purchase transaction or otherwise. The server encrypts the song key 8′ with the user key 6 and transfers the user-encrypted song key (UESK) 9 to the user's computer, which identifies the holes that were previously created by the burying process 17 and sprinkles 20 a copy of the UESK 9 into each hole. The sprinkled stream 21 can then be transferred to the personal player 12 as already described.

Alternatively, under the streaming model, FIG. 3, the sprinkling 20 is performed by the server 1 for each purchase transaction, or each time the song is played if the player 12 does not store the song.

For the purpose of explanation we shall assume that original source material has been presented with a bit depth of 16 bits since that is typical of current commercial practice, though the invention is clearly applicable also to sources having bit depths greater than or less than 16 bits. Neither the degradation process 16 nor the watermarking process 17 increases the bit depth, which remains at 16 bits and can be handled losslessly by existing players such as the iPod.

FIG. 3 shows the degradation 16 being performed before the burying 17. In an alternative implementation, these operations are performed in reverse order as far as the signal chain is concerned, the retrieval 24 and reconstruction 26 operations also being reversed. Performing the reconstruction 26 before the retrieval 24 raises causality considerations, since the reconstruction is dependent on prior retrieval of instructions. This problem can be resolved, for example by arranging that the burying 17 frees a sufficient quantity of least significant bit positions to hold the degradation instructions, and that the degradation itself does not affect the least significant bits of the signal.

A further variant is to combine the degradation and burying into a single operation. This can be done for example using the burying method described later, in particular making use of the lossless pre-emphasis methods shown in FIG. 13 and FIG. 14 of published International patent application WO2013/061062, which is hereby incorporated by reference. One degradation method consists of generating white pseudorandom noise, lowpass filtering the noise with for example four cascaded first-order filters each with a −3 dB point of 700 Hz, thus providing a combined ultimate slope of 24 dB/8 ve. The filtered noise signal may now be added to a constant slightly less than unity to provide the multiplier h shown in FIGS. 13 and 14 in published International patent application WO2013/061062. If the noise has suitable amplitude, the resulting degradation may be perceptually similar to that produced by lossy compression algorithms such as MP3.

Another way in which degradation and burying may be combined is explained later with reference to FIG. 12 of the present application.

The processes of reversibly degrading a stream or file and then encrypting the instructions required to reverse the degradation are together known as ‘perceptual encryption’. The practical differences from the plain encryption of FIG. 1 are firstly that a prior-art player or an unlicensed player can retrieve the lower-quality degraded version of the song, and secondly that the computational cost of the encrypting and decrypting the instructions 15 is expected to be vastly lower than the cost of encrypting and decrypting the song 14.

Although the degraded versions 21, 18 and 28 of the song are not precisely the same as each other, the audible effects of the burying unit 17 and the sprinkling unit 20 can be made small so that the three versions sound similar or identical to each other. Thus the degradation unit 16 is primarily responsible for the audible difference between the degraded signal 21, 21′ and the original song 14, 14′. Assuming suitable design of unit 16, the choice of instructions 15 can be made under artistic control and can be adapted to fulfil the commercial aim of allowing free distribution of a credible version 21 of the song while retaining an incentive to purchase a user-encrypted song key 9 so that the original song 14 may be reconstructed losslessly.

Thus the degraded song 18 in FIG. 2 is not considered valuable and can be freely circulated, a process known as ‘superdistribution’. The user may thus acquire the degraded song from friends, the important part of the purchase transaction being the transfer of the UESK 9 to the user.

### Signal Processing Aspects

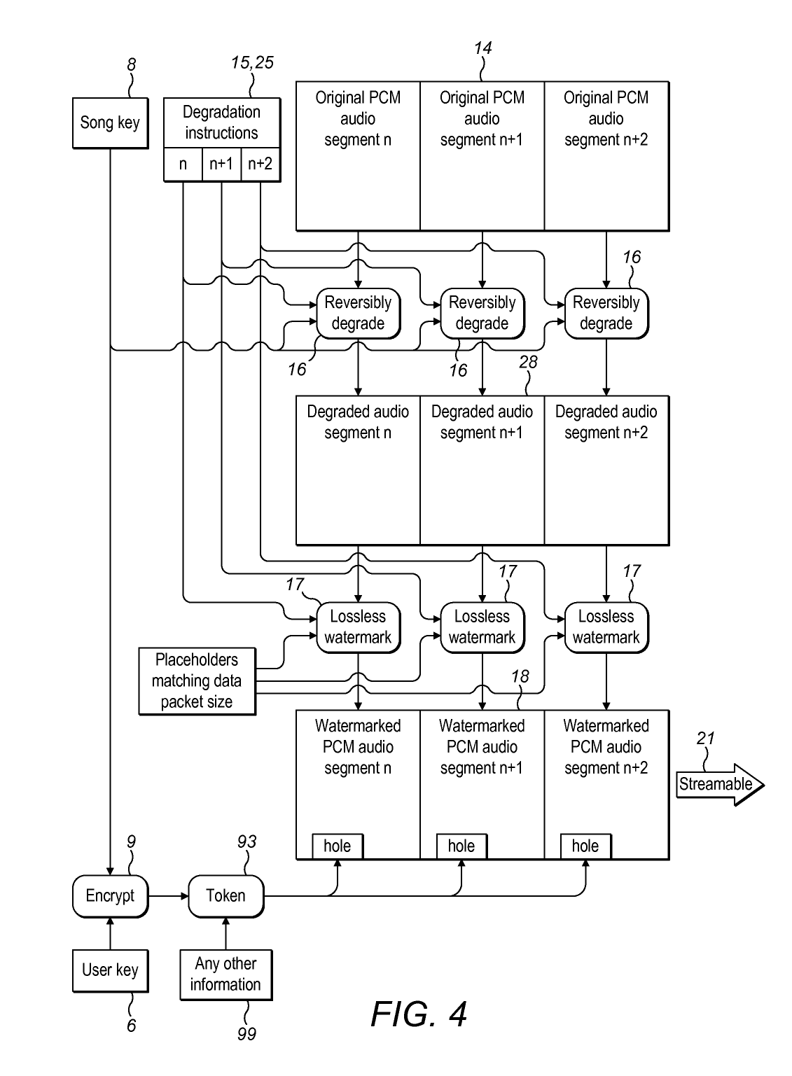

FIG. 4 gives details of some of the signal processing that may be needed to implement an encoder according to the invention.

The original PCM audio file or stream 14 is divided up into segments for the convenience of processing, three segments numbered n, n+1 and n+2 being shown. Each segment is degraded by a reversible algorithm 16, the nature and extent of degradation being controlled by the supplied degradation instructions 15 corresponding to that segment.

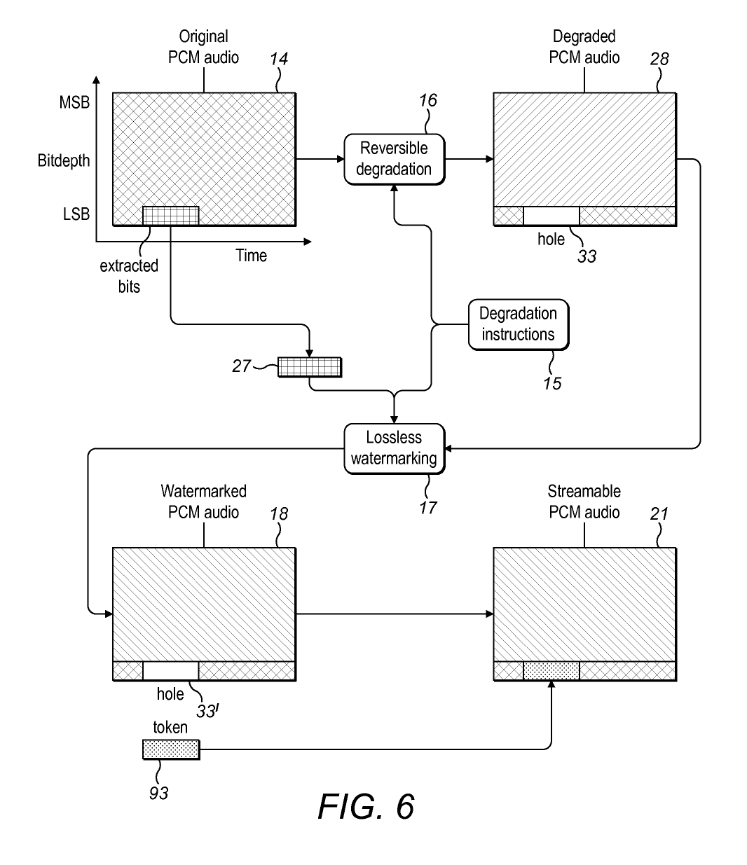

The degraded audio 28 is then operated on, segment by segment, by a lossless watermark process 17 which embeds into each audio segment data describing the degradation instructions 15 applied to that segment. The resultant watermarked PCM audio 18 has specified bit positions, termed holes and normally chosen from the least significant bit positions, which have the property that any data can be inserted there without upsetting the lossless invertibility of the watermarking process. One method of creating these holes will be described shortly with reference to FIG. 6.

A song key 8 will often be used to modify the above process at some point chosen to impede inversion of the process by an adversary who is not in possession of the song key. In FIG. 4, this modification is shown as modifying the step of reversible degradation 16 but it could be used to modify other steps instead or as well, for example encrypting the degradation instructions 15 before presentation to the lossless watermarking process, as shown in FIG. 3 and FIG. 4. Some embodiments, however, will not make use of a song key 8. In that case the single processing will be the same as shown in FIG. 4 except that the user key 6 and user-encrypted song key 9 will also be omitted.

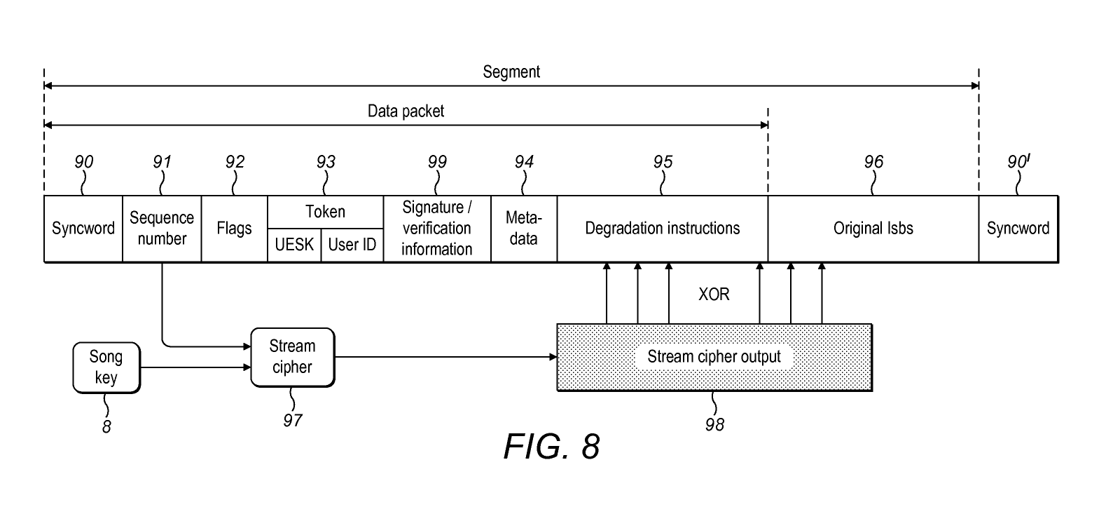

One method of modifying the reversible degradation makes use of a cryptographic random number generator such as the stream cipher 97 shown in FIG. 8, keyed by the song key to generate a sequence of pseudorandom numbers that are synchronised to a sample number or sequence number 91 and can thereby be identical between an encoder and a corresponding decoder. These pseudorandom numbers can then be used to modify the degradation process in a way that doesn't affect the general audio effect of the degradation but does affect its detail. For example, the degradation process may involve quantisations where it is preferable to add a small noise source to the signal prior to quantising it. This noise source can come from the pseudorandom number stream. Again, the pseudorandom number stream may be used to derive the filtered noise signal in the degradation method mentioned above with reference to FIGS. 13 and 14 of published International patent application WO2013/061062.

For computational efficiency of the server 1, the above processing can be performed once on a song 14 and the result 18 stored. Then at the point of delivery of the song to a user, the user key 6 is used to encrypt the song key 8 and thus furnish the User Encrypted Song Key (UESK) 9. Extra information 99 may optionally be added to this UESK 9 to form a token 93. Copies of this token are then placed into the holes to create the file which may be streamed to the user. The token copies may of course differ in the extra information 99 that has been added; moreover although FIG. 4 suggests that each hole will receive a copy of the token, this is not necessary and it may be preferred to omit the token from some segments in order to limit the total amount of data that is placed into holes which, although not shown in FIG. 4, will in general contain further data as will be explained later with reference to FIG. 8.

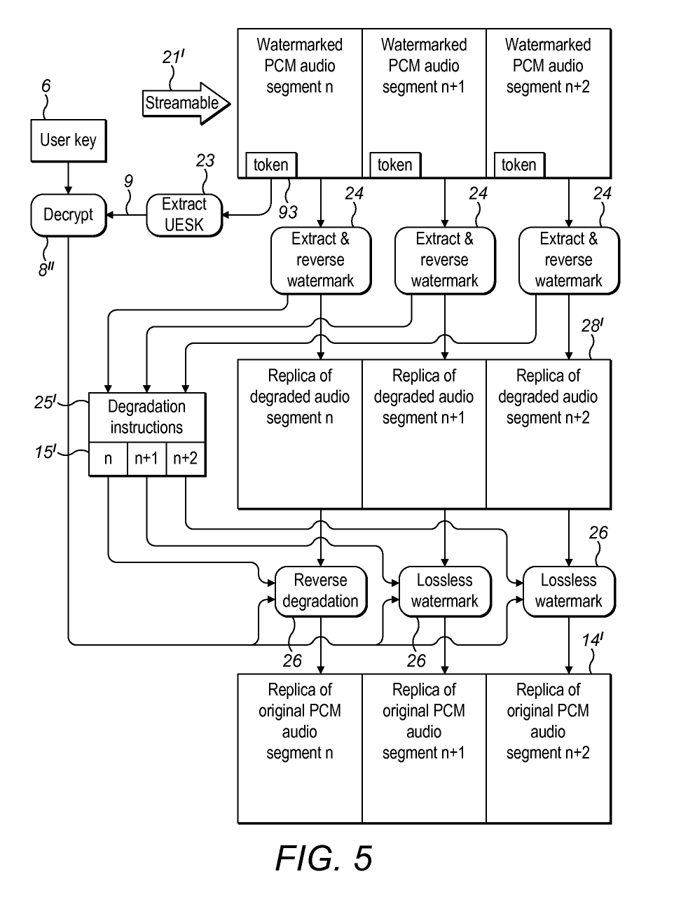

The corresponding decoder, FIG. 5, may extract the token 93 from a segment 21′ₙ of the received watermarked audio stream 21′ and parse 23 the token 93 to extract the UESK 9. It can then use the user key 6 to decrypt the UESK 9 and thus furnish a replica 8″ of the song key. Then, for each segment of the stream 21′, the decoder can invert 24 the lossless watermarking process, recovering the degradation instructions 25′ and an exact replica 28′ of the degraded audio. The instructions 25′, 15′ are then used to reverse 26 the degradation process and thus recover an accurate replica 14′ of the original PCM audio 14.

### Further Details of an Embedding Process According to the Invention

FIG. 6 gives an example of how signal information 27 may be extracted from a set of bit positions within a segment 14 of the audio and embedded 17 into the remaining audio using a method of lossless watermarking. The bit positions previously occupied by the extracted information 27 may be regarded as a “hole” 33, 33′ into which a specified sequence of bits, such as the token 93, may be inserted.

The bit positions comprising the hole 33 are preferably chosen from the least significant bits (Isbs) of the audio stream to minimise the audible effect of replacing their original content. Lossless watermarking 17 is used to embed the extracted original content 27 into the remainder of the audio. To avoid filling in the hole, the lossless watermarking process may conveniently be applied to the top 15 bits only of the 16-bit signal, so leaving the Isbs untouched including the hole.

The token 93 is thus inserted into the hole 33′ in the segment of watermarked audio 18 to furnish a segment 21 of PCM audio that can then be streamed.

FIG. 6 assumes that the reversible degradation also is configured to degrade the top 15 bits of the signal only, leaving the Isb and hence the hole untouched. The degradation instructions 15 governing the nature of the reversible degradation are also buried by the lossless watermarking 17 alongside the extracted bits.

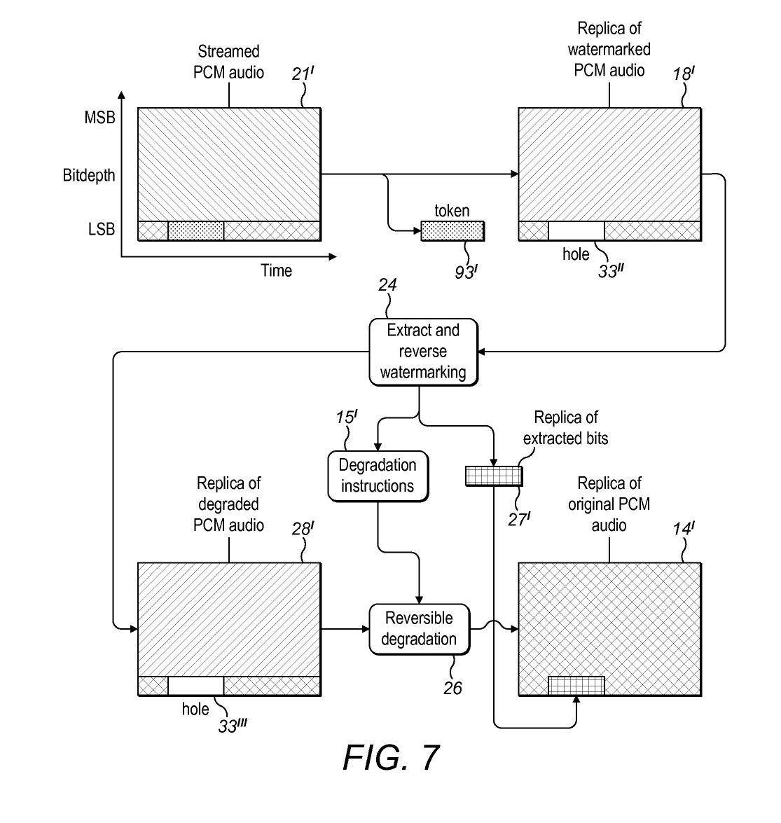

The corresponding decoder of FIG. 7 extracts the token 93′ from the streamed PCM audio 21′ and inverts 24 the watermarking operation on the top 15 bits of the audio, recovering the buried degradation instructions 15′ and the original signal information bits 27′. It then uses the degradation instructions 15′ to reverse 26 the degradation operations on the top 15 bits of the audio and then insert the original signal information bits 27′ back into the hole 33′″ to recover an exact replica 14′ of the original PCM audio.

It will also be apparent to those skilled in the art that there are many variations of the above operations that would achieve a similar effect and still be invertible in a corresponding decoder. For example, since neither the degradation nor the watermarking modify the Isbs, the bits could be extracted later in the process. Or, the reversible degradation could operate on all 16 bits of the audio if it is performed prior to the extraction of bits. Or the watermarking could operate on all 16 bits if it operates before the extraction and instead of burying the extracted bits from the current segment of audio it buries those from a prior segment.

Further Details of a Packet that May be Inserted According to the Invention

FIG. 8 shows the contents of the least significant bit positions of a segment of a watermarked audio stream, shown as 21 and 21′ in FIG. 6 and FIG. 7 respectively and where a data packet with fields 90, 91, 92, 93, 99, 94, and 95 has been inserted into the hole 33′. Also shown is how the song key 8 may conveniently be used to encrypt some fields of the packet after the packet has been inserted, in particular the degradation instructions 95.

A recognisable syncword 90 allows the decoder to search for the start of a data packet and thus synchronise itself to the stream, even if started partway through a song. A sequence number 91 identifies the segment 21 of audio associated with the data packet to allow synchronisation of pseudorandom number generator seeds between encoder and decoder. Data packets may contain optional fields, the flags 92 indicating which fields are present in a particular packet.

The token 93 and the signed verification information follow. Both are potentially large, so may not be present in every data packet, as indicated in the flags field. A further occasional field might be metadata 94 containing information about a track, such as the artist's name.

The fields mentioned so far are accessible “in the clear” but now may follow protected fields, such as the degradation instructions 95. This completes the data packet which may be assumed to occupy fully the hole 33′ and so for the rest of the audio segment 21, 21′ the least significant bit positions of the streamable audio will be occupied by the least significant bits 96 of the original audio segment 14. After that is the next segment, starting with its syncword 90′.

FIG. 8 shows a convenient method to encrypt the degradation instructions 95, which is to perform and exclusive-OR operation with a burst of cryptographically secure random data 98. A stream cipher such as Salsa 20 might be used to generate the random data. The cipher 97 receives the sequence number 91 and the song key 8 and scrambles them to produce for example 512 bits of pseudorandom data 98. The sequence number 91 is assumed to increment by one on each successive audio segment, and this procedure generates random data 98 that is consistent between encoder and decoder even if the decoder is started partway through a song.

A decoder can recover the song key from the UESK in the token 93, and pass it along with the sequence number 91 to another instance of the stream cipher 97 to replicate the stream cipher output 98. The decoder can thus repeat the exclusive-OR operation to recover the original unencrypted instructions 95. In the example shown in FIG. 8, the stream cipher output is longer than the degradation instructions so some of the original signal Isbs are also encrypted on encoding and correspondingly decrypted on decoding

The invention admits of several different methods to prevent unauthorised reversal of the degradation:
The degradation instructions may be encrypted prior to burying, as envisaged in FIG. 2
The degradation instructions may be encrypted after insertion into the hole, as envisaged in this FIG. 8
The degradation instructions may not be encrypted at all, security being obtained instead from the use of the cryptographically secure pseudorandom generator 97 to in the degradation process itself, as already mentioned.

These methods may of course also be used in combination. We refer to the information required to reverse the degradation as “degradation information”, comprising at least the degradation instructions but also the song key if the degradation makes use of pseudorandom numbers derived in dependence on the song key. “Embedding” information means incorporating the information into an audio stream, for example by burying the information directly using a method such as that described in published International patent application WO2013/061062, or alternatively by inserting the information into a hole 33′ as already described.

### Communication of the Device Encrypted User Key to the Device

Not discussed so far is the communication path shown in FIG. 1 whereby the Device Encrypted User Key (DEUK) 7″ is communicated from the server 1 to the playback device 3. This may be accomplished by generating a special song file in which the data packet of FIG. 8 contains a DEUK field. Thus DEUK is an additional optional field whose presence or absence is flagged 92. The special song file is thus specific to the device and is provided at device registration, to be played prior to playing normal song files. The device 3 thus extracts the DEUK from the packet and stores it 7. This process may be repeated if the device is to be registered to several users.

### Incorporation of Verification and Tracing Information

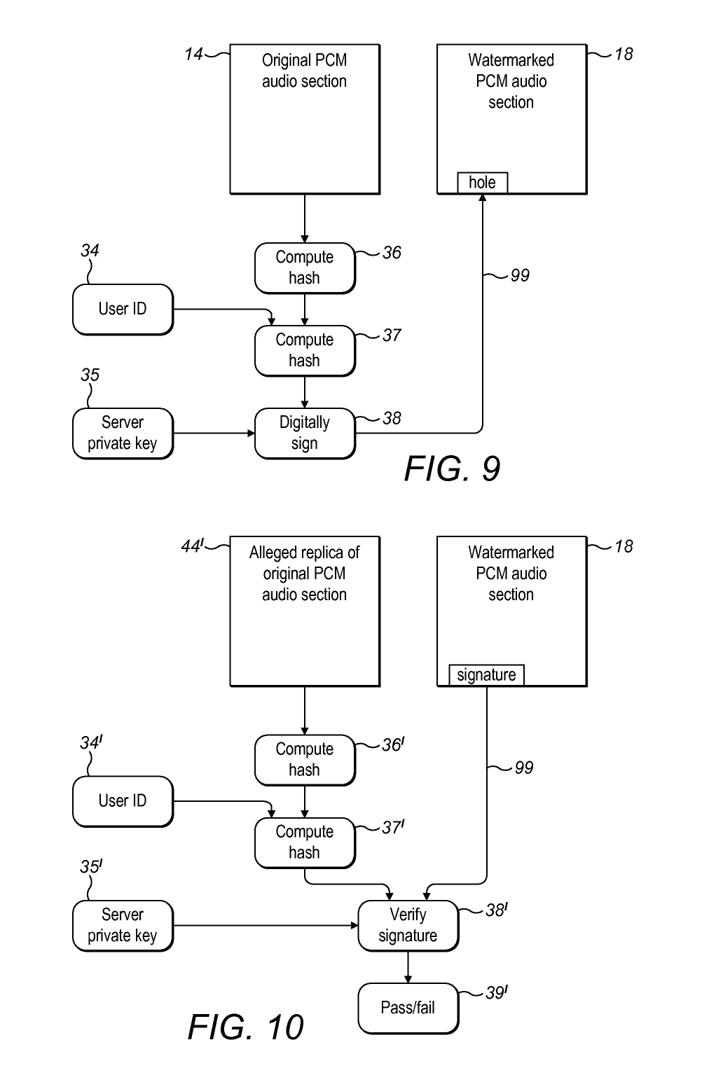

FIG. 9 gives an example of how verification information relating to the original PCM could be computed, combined with tracing information and buried in the streamable PCM audio. Typically a section 44 of the original audio stream is processed by a hashing function 36, for example SHA-256, to reduce its size. The section 44 may comprise several of the segments 14 previously referred to so that the necessary cryptographic computations in the remainder of the process are required less frequently. At the point of purchase, the server has knowledge of the User ID 34, which it combines with the output of the hash 36 in a further hash function 37, the output of which is then digitally signed 38 using the server's private key 35. Finally the signature 99 is inserted into a field of a data packet as shown in FIG. 8, the packet having previously been inserted into a hole in a segment 18 of watermarked audio, whose position within the stream bears a known relationship to the section 94 of original audio.

FIG. 10 shows the corresponding verification process in a decoder, in which a corresponding section 44′ of a decoded audio stream is reduced by an identical hashing process 36′ before being combined in a further hashing process 37′ with the User ID 34′ from a token 93 retrieved from a data packet as shown in FIG. 8. Also retrieved from a data packet is the signature 99 generated as described above from a corresponding section 44 of original audio. It is possible that the User ID 34′ and the signature 99 may come from data packets that have been inserted into different segments 18 of the watermarked audio. The verifier 38′ uses the server's public key 35′ to check that the result of the further hash function 37′ corresponds to the signature 99. If the signature verification fails, the decoder takes appropriate action such as indicating to the user that lossless reconstruction has not been verified and perhaps playing the degraded audio instead of the restored audio.

It will be appreciated that the above procedure could also be performed using a symmetric key making it a message authentication code instead of a digital signature. However use of a digital signature is advantageous so that compromise of a decoder does not compromise the signing key and allow an adversary to forge streamable audio without being detected as counterfeit by a decoder that checks the signature.

### Further Example of Lossless Data Burying Apparatus

FIG. 11 provides details of an apparatus that may be used to implement the methods of losslessly burying additional data into an PCM signal shown in FIG. 1 and FIG. 2 of published International patent application WO2013/061062. The skilled person will be able to furnish a more economical implementation from the algorithmic description given in the in the section “Gain Block”, pages 15-18 of published International patent application WO2013/061062, but it may be easier to verify the functional correctness of the architecture of this FIG. 11. It is assumed that the gain g used for burying satisfies ½<g<1.

In the encoder of FIG. 11 (a), the original signal 100 is multiplied 104 by the inverse gain 1/g then quantised 105 to furnish the quantised signal 112. The multiplexer 119 receives the signal 112 and, conditionally on the control signal 129, may pass a sample of signal 112 to its output as a sample of the composite signal 101.

In the decoder of FIG. 11 (b), the composite signal 101 is multiplied 154 by the gain g and quantised 155 to form the reconstructed signal 102. On the assumption that the composite signal 101 is equal to the quantised signal 112, the reconstructed signal 102 will be equal to the original signal 100 provided that the original signal 100 takes only quantised values and that the two quantisers 105 and 155 are suitably matched. The diagram shows two types of quantiser, Q⁺ and Q₋, where quantisers 105 and 121 are of type Q⁺ while quantisers 115, 125, 135, 145 and 155 are of type Q₋. Suitable choices would be that Q⁺ is a ceiling quantiser while Q₋ is a floor quantiser, or alternatively that both are rounding quantisers but that for the critical case Q(i+½) where i is integer, Q⁺ rounds up but Q₋ rounds down.

Returning to the encoder, FIG. 11 (a), the signal 112 is multiplied 124 by g and quantised 125, units 124 and 125 thus mimicking the actions of units 154 and 155 in the decoder for the case where the multiplexer 110 passes signal 112. Units 114 and 115 also mimic these actions, except that they process signal 113 which is greater by one than signal 112, by virtue of the adder 106.

Thus units 124 and 125 simulate the decoding of signal 112, while units 114 and 115 simulate the decoding of signal 113. Comparator 126 tests whether these two decodings produce the same result. If not, the logic value 128 is false, so the output 129 of AND gate 127 is also false. Multiplexer 119 is configured to interpret a false value of control signal 129 as an instruction to pass signal 112, thus ensuring that the reconstructed output 102 is equal to the original signal 100 as discussed above.

If the two simulated decodings of 114, 115 on the one hand and 124, 125 on the other do produce the same result then encoder has choice of which of signals 112 and 113 should be passed as the composite signal 101, such that the decoder of FIG. 11 (b) will produce the correct reconstructed signal 102 in either case. Thus on the comparator 126 detecting that the two simulated decodings are indeed the same, logic value 128 is true and a bit is clocked out of buffer 103 containing additional data to be buried, passed through AND gate 127 and therefore conveyed as control signal 129 to select which of 112 and 113 should be passed as composite signal 101.

Since the reconstructed signal 102 is equal to the original signal 100, it follows that units 120, 121, 136, 134, 135, 144, 145 and 146 in the decoder will duplicate exactly the actions of corresponding units 104, 105, 106, 114, 115, 124, 125 and 126 in the encoder. Thus logic signal 148 in the decoder is true if and only if logic signal 128 in the encoder was true, implying that a bit had been clocked out of buffer 103. Since signal 133 in the decoder is a replica of signal 113 in the encoder, the output of comparator 149 indicates whether signal 113 is equal to the composite signal 101, and hence, since the signal 112 is always different from signal 113, the value of the control signal 129. Thus, the comparator 149 furnishes a bit that is a replica of the bit that was clocked out of buffer 103; this bit is now clocked into the buffer 143.

Thus data is conveyed from buffer 103 to buffer 143 at a varying rate, one bit being conveyed each time the outputs of quantisers 115 and 125 are equal.

The architectures of FIG. 11 (a) and FIG. 11 (b) may be simplified, units 124 and 125 being deleted and the original signal 100 being fed directly to comparator 126; similarly the units 144 and 145 being deleted and the reconstructed signal 102 being fed to the comparator 146. Other functionally equivalent architectures were described in the section “Gain Block”, pages 15-18 of published International patent application WO2013/061062.

FIG. 12 is akin to FIG. 11 but with addition or subtraction units 160, 161 and 162 in the encoder of FIG. 12(a) and units 163, 164 165 and 166 in the decoder of FIG. 12 (b). These units allow for the addition and subtraction of a dither signal r as described in the section “Gain Block”, pages 28-39 of published International patent application WO2013/061062.

Another possibility is to use the signal r to inject deliberate degradation to the signal composite signal, for example if the signal r is “modulation noise” as mentioned earlier and possibly derived by multiplying the audio signal by a pink noise. In this case, the operations of degradation and burying are merged, and the “degraded signal” of the current application may be identified with the “composite signal” of published International patent application WO2013/061062. Alternatively, noting that the gain g may be varied from sample to sample if desired, the operations of degradation and burying may be combined by deriving g from a noise-like signal such as a pink noise.

To improve the perceived quality of the composite signal prior to degradation, the signal r may be the sum of a dither signal and a degradation signal.

1. A method of providing a streamable PCM signal allowing conditional access to a lossless presentation of an original PCM signal, the streamable PCM signal having the same sample rate and bit-depth as the original PCM signal and providing a controlled audio quality when played on standard players, the method comprising the steps of:
reversibly degrading a representation of the original PCM signal in dependence on degradation information for degrading the original PCM signal;
embedding the degradation information into the representation using a method of lossless watermarking;
creating a token in dependence on additional information; and,
inserting the token into the degraded representation to provide the streamable PCM signal.

2. A method according to claim 1, wherein the step of inserting is performed periodically.

3. A method according to claim 1, wherein the degradation information comprises degradation instructions.

4. A method according to claim 1, further comprising the step of receiving a song key, wherein at least one of the reversibly degrading step and the embedding step is performed in dependence on the song key, and wherein the token is created in dependence on the song key.

5. A method according to claim 4, further comprising the steps of:
receiving a user key; and,
encrypting the song key with the user key to furnish a user encrypted song key, wherein the token is created in dependence on the user encrypted song key.

6. A method according to claim 5, the method comprising the further step of receiving tracing information relating to the user or transaction,
wherein the step of creating the token comprises combining the user-encrypted song key with the tracing information.

7. A method according to claim 5, wherein the token consists of the user-encrypted song key.

8. A method according to claim 5, further comprising the steps of:
establishing a secret device key relating to a playback device;
encrypting the user key with the device key; and,
communicating the device-encrypted user key to the device.

9. A method according to claim 8, wherein the step of establishing a secret device key comprises the steps of:
receiving a device identifier; and,
retrieving the secret device key from a database linking device keys with device identifiers.

10. A method according to claim 8, wherein the step of communicating the device-encrypted user key comprises the steps of:
selecting a segment of PCM audio material;
hiding the device-encrypted user key in the PCM audio material; and,
communicating the segment of PCM audio material to the playback device.

11. A method according to claim 4, wherein the step of reversibly degrading is performed in dependence on the song key.

12. A method according to claim 4, wherein at least some of the degradation information is encrypted in dependence on the song key prior to embedding.

13. A method according to claim 4, wherein at least some of the degradation information is encrypted in dependence on the song key after embedding.

14. A method according to claim 1, wherein the representation of the original PCM signal to be degraded is a copy of the original PCM signal.

15. A method according to claim 1, wherein the representation of the original PCM signal to be degraded comprises a succession of segments of the original PCM signal stored in computer memory.

16. A method according to claim 1, further comprising the step of receiving the original PCM signal.

17. A method according to claim 1 comprising the further step of:
extracting signal information that was conveyed in a set of predetermined bit positions within the representation and embedding said signal information into the representation excluding the bit positions in the predetermined set,
wherein the step of inserting is performed by placing the token into bit positions within the predetermined set.

18. A method according to claim 1, further comprising the step of embedding verification information at intervals into the degraded representation,
wherein each instance of the verification information is computed in dependence on a separate segment of the original PCM signal and on the token.

19. A method according to claim 18, wherein the verification information comprises a digital signature.

20. A method according to claim 1, comprising the further step of transmitting the token and the degraded representation from a server to a client, wherein the step of inserting is performed after the step of transmitting.

21. A method according to claim 1, comprising the further step of receiving the degradation information.

22. A method of providing a streamable PCM signal allowing conditional access to a lossless presentation of an original PCM signal and to additional information, the streamable PCM signal having the same sample rate and bit-depth as the original PCM signal and providing a controlled audio quality when played on standard players, the method comprising the steps of:
reversibly degrading a representation of the original PCM signal in dependence on degradation information for degrading the original PCM signal;
embedding the degradation information and additional information into the representation using a method of lossless watermarking;
creating a token in dependence on the additional information; and,
inserting the token into the degraded representation to provide the streamable PCM signal.

23. A method according to claim 22, wherein the additional information comprises verification information.

24. A method according to claim 22, wherein the additional information comprises a digital signature.

25. A method according to claim 22, further comprising the step of receiving tracing information relating to a user or transaction, wherein the additional information comprises the received tracing information.

26. An electronic device to provide a streamable PCM signal allowing conditional access to a lossless presentation of an original PCM signal, the streamable PCM signal having the same sample rate and bit-depth as the original PCM signal and providing a controlled audio quality when played on standard players, the device comprising:
a processor; and,
a memory in communication with the processor, the memory storing program instructions, the processor operative with the program instructions to:
reversibly degrade a representation of the original PCM signal in dependence on degradation information for degrading the original PCM signal;
embed the degradation information into the representation using a method of lossless watermarking;
create a token in dependence on additional information; and
insert the token into the degraded representation to provide the streamable PCM signal.

27. A system comprising two or more electronic devices each configured to provide a streamable PCM signal allowing conditional access to a lossless presentation of an original PCM signal, the streamable PCM signal having the same sample rate and bit-depth as the original PCM signal and providing a controlled audio quality when played on standard players, wherein each device comprises:
a processor; and
a memory in communication with the processor, the memory storing program instructions, the processor operative with the program instructions to:
reversibly degrade a representation of the original PCM signal in dependence on degradation information for degrading the original PCM signal;
embed the degradation information into the representation using a method of lossless watermarking;
create a token in dependence on additional information; and
insert the token into the degraded representation to provide the streamable PCM signal.

28.-30. (canceled)
